(19) United States
(12) Patent Application Publication
(10) Pub. No.: US 2008/0318025 A1
(43) Pub. Date: Dec. 25, 2008

(54) INK ABSORBENT

(75) Inventors: Shimpei Kurokawa, Fuji-shi (JP); Teruo Miura, Fuji-shi (JP); Akihide Ishizawa, Fuji-shi (JP); Masaki Okada, Fuji-shi (JP)

Correspondence Address: CONNOLLY BOVE LODGE & HUTZ LLP, 1875 EYE STREET, N.W., SUITE 1100, WASHINGTON, DC, 20006, US

(73) Assignees: Oji Kinocloth Co., Ltd., Shizuoka-Ken (JP); Oji Paper Co., Ltd., Tokyo (JP)

(21) Appl. No.: 12/027,390

(22) Filed: Feb. 7, 2008

(30) Foreign Application Priority Data
Feb. 9, 2007 (JP) 2007-030302

(51) Int. Cl. B41M 5/50

(52) U.S. Cl. 428/319.3; 428/304.4; 428/318.4

(57) ABSTRACT

An ink absorbent including a base sheet comprising a dry nonwoven fabric having the density of 0.05 to 0.5 g/cm³ and a porous member fitted to the base sheet, wherein the density of the porous member is lower than one of the base sheet, is provided.

Priority is claimed to Japanese application No. 2007-030302, filed Feb. 9, 2007, the content of which is incorporated herein by reference.

### TECHNICAL FIELD

The present invention relates to an ink absorbent which can absorb various types of waste liquid such as oil, solvent, or the like produced from machinery installed in the house or business place such as a factory, and mainly which is suitable for absorption of waste ink produced from an inkjet printer.

### BACKGROUND OF THE INVENTION

In general, in an inkjet printer, ink is previously dropped before or during printing in order to prevent the ink head from clogging.

Various constitutions have been known as an ink absorbent (hereafter also referred to as absorbent) for absorption of ink when dropping and, for example, disclosed in JP 08-311755 (Patent document 1), JP09-158024 (Patent document 2), and the like.

Also, dropping of ink is generally conducted in the state where an ink head is located at a fixed point of an inkjet printer. Therefore, it means that the ink of the inkjet printer continues to be dropped at the certain point of absorbent.
[Patent document 1] Japanese Laid-Open Patent Application No. Hei 8-311755
[Patent document 2] Japanese Laid-Open Patent Application No. Hei 9-158024
[Patent document 3] Japanese Laid-Open Patent Application No. 2000-135797
[Patent document 4] Japanese Laid-Open Patent Application No. 2003-39754

### SUMMARY OF THE INVENTION

Ink for an inkjet printer is classified broadly into dye ink including dye as a coloring agent and pigment ink including pigment. Recently, pigment ink having excellent water resistance and weather resistance has become commonly used in order to improve printing quality.
In the case of using dye ink or pigment ink, ink having high density has been used in order to prevent problems such as bleeding or the like.
By an increase of a solid content or the like due to the high density of ink, the viscosity of ink becomes higher making an absorption and diffusion penetration difficult.

Therefore, the ink on the surface of the absorbent behaves so as to cause the following phenomenon. That is, in the case of repeatedly dropping ink to the absorbent and drying the ink, a film of deposit may be formed on the surface of the absorbent and gradually laminated to prevent the ink from diffusing.

The diffusion of the pigment component in the pigment ink is more difficult than one of the dye content in the dye ink having high density and the pigment by itself clogs the solvent flow path consisting of the porous structure of the absorbent. Therefore, in the case of using the absorbent continuously, the absorption thereof reduces and the pigment is accumulated at the point on the surface of the absorbent where the ink is dropped.

As a result, there are problems in that ink is leaked from an ink absorbent of an inkjet printer, a printing paper is stained by contacting a printing paper and an accumulated point of the surface of the ink absorbent when printing, etc.

In order to solve those problems, the art of Japanese Laid-Open Patent Application No. 2000-135797 (Patent document 3), Japanese Laid-Open Patent Application No. 2003-39754 (Patent document 4), or the like is disclosed.

However, because, in order to improve printing quality, the tendency to increase the density and viscosity of an ink is growing, it is required that various performances such as absorption, diffusion from the surface to the inside, or liquid keeping property are improved.

The present invention includes the following feature in order to solve the above problems.

A first aspect of the present invention is an ink absorbent which includes a base sheet comprising a dry nonwoven fabric having a density of 0.05 to 0.5 g/cm³ and a porous member fitted to the base sheet, in which the density of the porous member is lower than that of the base sheet.

A second aspect of the present invention is an ink absorbent according to the first aspect, in which the base sheet is formed by a cellulose fiber as a main body.

A third aspect of the present invention is an ink absorbent according to the first aspect, in which the base sheet is formed by a synthetic fiber as a main body.

A fourth aspect of the present invention is an ink absorbent according to any one of the first aspect to the third aspect, in which the porous member is a nonwoven fabric having a density of 0.01 to 0.20 g/cm³

A fifth aspect of the present invention is an ink absorbent according to the fourth aspect, in which the nonwoven fabric is formed by a synthetic fiber having a fineness of 0.1 to 72 dt.

A sixth aspect of the present invention is an ink absorbent according to any one of the first aspect to the third aspect, in which the porous member is formed by a synthetic resin foam, the diameter of a pore size of which is within the range of from 0.01 to 3.0 mm.

The present invention can provide an ink absorbent which can absorb various types of waste liquid such as oil, solvent, or the like produced from machinery installed in the house or business place such as a factory, and mainly which is suitable for absorption of waste ink produced from an inkjet printer.

### BRIEF DESCRIPTION OF DRAWINGS

Some of the features and advantages of the invention have been described, and others will become apparent from the detailed description which follows and from the accompanying drawings, in which:

FIG. 1 is a schematic view showing a cross-section according to the present invention,

FIG. 2 is a schematic view showing a cross-section according to the present invention, and

FIG. 3 is a perspective view showing an example of the present invention.

### DETAILED DESCRIPTION OF THE INVENTION

The invention summarized above and defined by the enumerated claims may be better understood by referring to the following detailed description, which should be read with reference to the accompanying drawings. This detailed description of particular preferred embodiments, set out below to enable one to build and use particular implementations of the invention, is not intended to limit the enumerated claims, but to serve as particular examples thereof.

An ink absorbent of the present invention is specifically described below.

First, the present invention provides an ink absorbent, which includes the above-described features and combines a porous member having excellent osmosis and diffusion of the ink and especially penetrability of the pigment component and a base sheet having a function of keeping ink.

That is, in the case of using an ink absorbent of the present invention installed in an inkjet printer, a point where an ink is dropped from an ink head is set to be a point where the porous member is disposed. Due to the construction, effects in which an ink having high viscosity or pigment ink is osmosed and quickly diffused into a porous member to prevent a pigment component or deposited component from accumulating at the dropping point and the absorption of the whole absorbent improves can be obtained.

Next, a base sheet of an ink absorbent of the present invention is explained below. As a dry nonwoven fabric to be a base sheet having the density of 0.05 to 0.5 g/cm³, it is possible to use a well-known dry nonwoven fabric suitably chosen according to purpose. “Density” of the present invention means an apparent density unless otherwise stated.

“Dry nonwoven fabric” of the present invention means the broad sense of the term and includes all nonwoven fabrics which are not included in a wet nonwoven fabric.

For example, a nonwoven fabric produced by a binder immersion method, binder print method, binder spray method, adhesion fiber method, needle punch method, stitch bond method, spun lace method, melt blow method, spun bond, or the like, is arbitrarily selectable as a dry nonwoven fabric.

Also, as a material of a nonwoven fabric to be a base sheet of the present invention, a natural fiber including cotton, hemp, wool, pulp, and the like,

a synthetic fiber including a rayon fiber in which natural cellulose is a raw material, polyolefin (PO) system fiber such as polyethylene (PE), polypropylene (PP), or the like, polyester (PET) fiber polyamide fiber, and acrylic fiber, or a bicomponent fiber consisting of the combination of plural synthetic resins is arbitrarily selectable.

Plural fibers among those materials can be arbitrarily selected and combined.

Examples of an especially suitable nonwoven fabric which can be used as a base sheet of an ink absorbent of the present invention are specifically described below.

As the base sheet of the present invention, dry nonwoven fabric consisting of cellulose fiber as a main body is suitably used.

Examples of a used cellulose fiber include a natural cellulose fiber such as a wood pulp, linter, and various non-wood vegetable fibers.

In addition, wood pulp such as chemical pulp or mechanical pulp made from a conifer and a broadleaf tree, and non-wood nature pulp such as wastepaper pulp, hemp, and cotton are included.

Also, the rayon fiber which is produced by using the above-described natural cellulose as raw materials is included in the cellulose fiber.

A nonwoven fabric including cellulose fiber as a main body includes those in which another fiber such as synthetic fiber is included within the range in which the other fiber does not hinder the effect of the present invention.

As an added synthetic fiber, an arbitrary material can be used according to conditions.

For example, PO system fiber such as PP and PE, PET fiber, polyamide fiber, and the like are included.

In addition, a bicomponent fiber consisting of a combination of synthetic resins having different melting point can be used.

Examples of the combination include PE/PP, PE/PET, PP/PET, low melting PET/PET, low melting PP/PP, nylon 6/nylon 66 (trademark), and the like and the combination thereof is arbitrarily selectable.

In addition, a side-by-side type bicomponent fiber, in which different resins are spun in parallel, a core sheath type bicomponent fiber, in which the low melting resin is spun at the outside and the high melting resin is spun at the inside, and the like are available as a bicomponent fiber.

Although a fiber length and fiber diameter are arbitrarily selectable, it is most preferable that the fiber length be within the range of from 2 to 6 mm and the fiber diameter be within the range of from 1 to 72 dt.

As a dry nonwoven fabric obtained by using a natural cellulose fiber among the cellulose fibers, it is preferable to use those obtained by a thermal bond method in which fiber is mechanically decomposed in dry conditions, the fiber is mixed with a thermal adhesive material, and web consisting of fiber is continuously formed on a driving wire and heated to be a sheet.

Also, as a dry nonwoven fabric obtained by using a rayon fiber as cellulose fiber, it is preferable to use those obtained by a needle punch method in which rayon fiber is mechanically compounded and bonded to be felty.

In a nonwoven fabric obtained by using the above thermal bond method, a cellulose fiber and other structural component are adhered and fixed via a thermal adhesive material.

As a thermal adhesive material, a material which can adhere and fix a component of a base sheet by a thermal adhesive and is in the form of a fiber, powder, grain, or the like is used. Among thermal adhesive materials, a synthetic fiber having a thermal adhesive is most preferable because synthetic fiber itself functions as both of a fiber and thermal adhesive material.

Also, a thermal adhesive fiber and thermal adhesive powder may be mixed and used.

As a thermal adhesive material, at least one kind selected from the group consisting of polyethylene, polypropylene, ethylene/vinyl acetate copolymer, a polyamide, and polyester is desirable.

Also, as a thermal adhesive powder, a product with 20 mesh pass and 300 mesh on is preferable. In a case of a product larger than a product with 20 mesh pass and 300 mesh, if resins are mixed in the same quantity, the number of adhered points reduces worsing efficiency. On the other hand, in a case of a product smaller than a product with 20 mesh pass and 300 mesh on, it is difficult to fix thermal adhesive powders between fibers because thermal adhesive powders pass through a back sheet or mess conveyor when forming a web.

In the case of using an ink absorbent under high temperature, for example, in the case of putting it into an inkjet printer, a fire-retardant material can be added to a nonwoven fabric according to need to provide fire retardance.

A fire-retardant material can be selected from well-known materials. For example, a boric acid and borax (sodium tetraborate) powder are preferable from the point of being cheap in addition to having excellent safety.

In addition, antimony oxide, a phosphorus system compound, a nitrogen system compound, a bromine compound, a bridging body of sodium polyacrylate, which is sold as a high superabsorbent polymer being highly hydrous, or the like can be used. These fire-retardant agents may be appropriately mixed and used according to need.

In the case of adding a fire retardant, a thermal adhesive fiber having fire retardance can be used as a material of a nonwoven fabric. As this thermal adhesive fiber, ES243 (product name) made by Chisso Corporation, which is an olefinic system bicomponent fiber having fire retardance, is preferably used.

When it is necessary to improve the liquid holding force of an ink absorbent of the present invention after absorbing liquid, a viscosity improver material is added to a nonwoven fabric to improve the viscosity of the absorbed ink and, as a result, the liquid holding force of absorbent is improved.

A viscosity improver material can be selected from the well-known materials.

For example, carboxymethyl cellulose (CMC), polyvinyl alcohol (PVA), polysodium acrylate, or a polyethylene oxide (PEO) is preferable. These exemplified viscosity improver materials can provide an excellent viscosity even if used in a small amount. In addition, the solubility to water at normal temperature and the cost performance are excellent.

When it is necessary to accelerate the effect of the liquid holding force due to the above viscosity improver agent, a crosslinker may be further added. A crosslinker can be selected from a well-known material.

For example, potassium alum, aluminium sulfate, aluminum acetate, calcium hydroxide, ferrous sulfate, ferric chloride, zinc sulfate, barium chloride, silver nitrate, cupric chloride are preferable.

Because, even if a small amount is used, the exemplified crosslinker can gelatinize liquid early, and the liquid holding force improves.

In addition, the solubility to water at normal temperature and the cost performance are excellent.

In the case of a base sheet including dry nonwoven fabric which has the above cellulose fiber as a main body, it is especially preferable that a viscosity adjusting material (viscosity improver agent and crosslinker) be blended so as to be 1 to 50% of the whole of 30 to 90 parts by mass of a cellulose fiber and 70 to 10 parts by mass of the above thermal adhesive material, because a sufficient viscosity can be added to an absorbed liquid while holding an entire amount of an adsorbed liquid.

On the other hand, it is better for a pigment ink to prioritize the osmosis or diffusion of ink to the whole absorbent over the effect of holding liquid in order to improve the absorbent ability.

Therefore, when mainly absorbing pigment ink it is more desirable for a component added to an absorbent to be selected from those which cannot react with ink or improve the viscosity. For example, when a fire-retardant agent is added, the use of a fire-retardant agent such as nitrogen system, phosphorus system, or the like is more desirable than the use of a borax improving the viscosity.

Also, as a base sheet of ink absorbent of the present invention, other examples that can be preferably used are specifically described below.

As a base sheet of the present invention, a felt nonwoven fabric is preferably used. Felt nonwoven fabric indicates a nonwoven fabric composed by mechanically compounding and bonding fibers by the needle punch method.

As a fiber for the above felt nonwoven fabric, it is desirable that the fiber length be within the range of from 3 to 80 mm and the fineness be within the range of from 0.6 to 72 dt.

When the fiber length is less than 3 mm, there are problems in that it is difficult to entwine a fiber depending on a needle and omission of fiber may occur. When the fiber length is more than 80 mm, there are problems in that it is difficult to form a uniform web.

When the fineness is less than 0.6 dt, there are problems in that it is difficult to form a uniform web because a fiber is entwined sparsely. When the fineness is more than 72 dt, there are problems in that it is difficult to entwine a fiber and form nonwoven fabric with sufficient strength.

As a material of a fiber for the above felt nonwoven fabric, the fiber including a synthetic resin which can be used for the above-described dry nonwoven fabric can be used.

It is especially preferable to use polyester, polypropylene, rayon, acrylic, or the like from the point of ink osmosis ability and cost performance.

Also, in the above-described felt nonwoven fabric, a fire retardant can be added according to need by the method in which a fire-retardant material may be added or a fire retardant fiber is used, etc.

A fire-retardant material and fire retardant fiber which can be used in this case, can be the same as used in the dry nonwoven fabric including the above-described natural cellulose fiber as the main body

In the above felt nonwoven fabric, when it is necessary to improve a liquid holding force of an ink absorbent after absorbing liquid, a viscosity improver material can also be added to a nonwoven fabric to improve the viscosity of the absorbed ink. In this case, a fire-retardant material and fire retardant fiber can be the same as used in the dry nonwoven fabric including the above-described natural cellulose fiber as the main body.

In the present invention, a synthetic resin fiber sheet may be laminated on the surface and/or the back of the above-described base sheet.

As this synthetic resin fiber sheet, a sheet including nonwoven fabric such as a thermal bond nonwoven fabric, spun bond nonwoven fabric, and the like is suitably used. It is desirable that the density be within the range of from 0.01 to 0.3 g/cm³, the thickness be within the range of from about 0.2 to 5 mm, and the basis weight be within the range of from 20 to 300 g/m².

A synthetic resin fiber sheet is laminated by adhering the surface and/or the back of the above-described base sheet via a hotmelt adhesive agent, thermal adhesive material, or the like.

The density of a nonwoven fabric used as a base sheet of an ink absorbent in the present invention is within the range of from 0.05 to 0.5 g/cm³, and is more preferably within the range of from 0.1 to 0.3 g/cm³. When the density is less than 0.05 g/cm³, because the cavity of the nonwoven fabric is too large, a holding force of absorbed liquid is worsened. Also, because an omission of a viscosity improver material or fire-retardant material with powder-grain form increases, it is not suitable for products.

On the other hand, when the density is more than 0.5 g/cm³, because the cavity is too low, the amount of the adsorbed liquid is insufficient.

The basis weight of a nonwoven fabric used as a base sheet of ink absorbent in the present invention is preferably within the range of from 100 to 4000 g/m² and more preferably within the range of from 250 to 3100 g/m². When the basis weight is less than 100 g/m², it may be too thin for a base material of an absorbent in the present invention to absorb sufficient ink. When the basis weight is more than 4000 g/m², there are problems in that an absorbent itself is too large and a space for a printer including the large absorbent is too large.

A porous member of ink absorbent of the present invention is explained.

A porous member of the present invention is a base material including numerous cavities which can permeate or diffuse solvent of ink and pigment component and, in particular, a base material such as nonwoven fabric and synthetic resin foam is preferably used.

In addition, a sintering porous body such as a ceramic sintering porous body, a plastic sintering porous body, and the like can be used.

The density of a porous member is preferably within the range of from 0.01 to 0.28 g/cm³ and more preferably within the range of from 0.03 to 0.20 g/cm³. When the density is less than 0.01 g/cm³, because solvent component or pigment component of ink cannot be diffused, ink may be dropped only in a vertical direction. When the density is more than 0.28 g/cm³, because the number of cavities reduces, diffusion of ink may be blocked.

A porous member the density of which is lower than one of a base sheet fitted with the porous member is applied. Due to the density of a porous member being lower than one of a base sheet, dropped ink becomes passes the porous member and diffuses with ease.

As a porous member, a material which cannot absorb a solvent component of ink is preferably used. If a porous member adsorbs solvent, dropped ink is prevented from diffusing to the base sheet. Also, because the porous member solvent is swollen with the solvent component and a cavity therein narrows, the pigment is prevented from diffusing.

In addition, it is desirable that the surface a porous member be solvent-attracting.

For example, in the case of using aqueous ink, it is desirable that a material the surface of which is hydrophilic or a material on which a hydrophilic treatment is previously conducted be used. That is, osmosis and diffusion of ink can be conducted for a short time by just using a member the surface of which is hydrophilic for aqueous ink.

In addition, as a method of a hydrophilic treatment, a method of applying arbitrarily hydrophilizing chemicals including various surfactants such as glycerin or a fluorine system surfactant (megafuc F-470 or the like) to a porous member and method of immersing a porous member in arbitrarily hydrophilizing chemicals are included.

In the case of using oil ink, it is desirable that the surface of a porous member be lipophilic.

A part of the above-described base sheet is cut and the porous member is fitted into the cut part of the base sheet to be an ink absorbent of the present invention.

A form and size of a porous member is arbitrarily determined within the range able to fit the above-described base sheet.

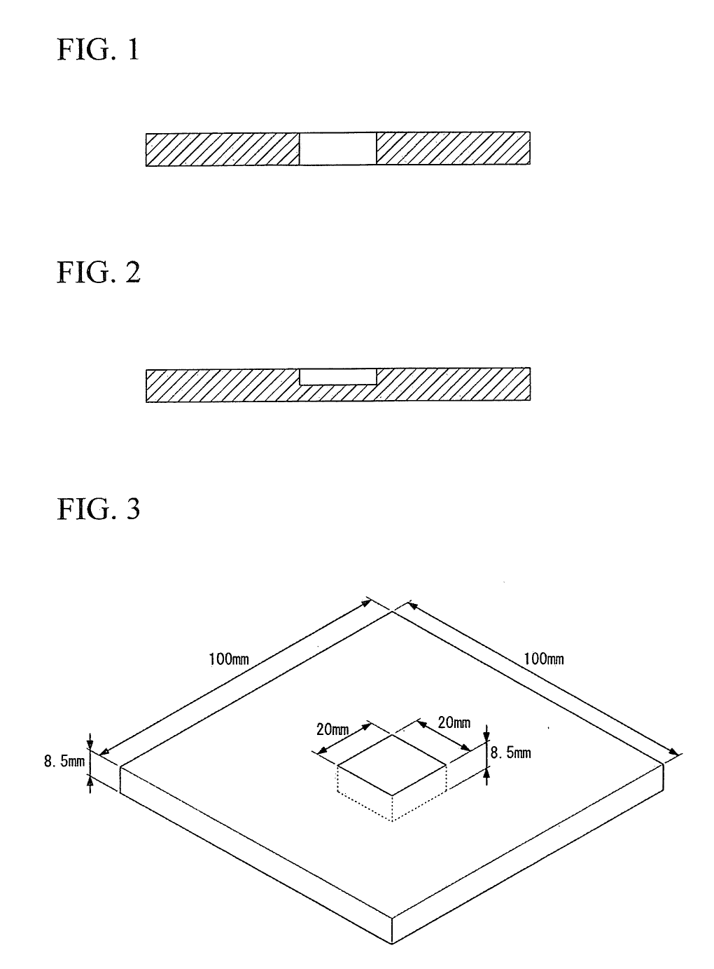

As a method of fitting a porous member, a method of fitting a member into the cut part where the base sheet is cut so as to pierce above and below in the direction of thickness (shown in FIG. 1) and a method of fitting a member into the cut part where the base sheet is cut partway through the thickness (shown in FIG. 2) may be included and the method is arbitrarily determined according to condition.

In the relationship of a porous member and a size and shape of a cut part in a base sheet, it is desirable that the size of a porous member be the same as or a little larger than one of the cut part of a base sheet. The reason it is not necessary to fix a porous member by means such as an adhesive agent, is because the porous member being a little larger than the cut part is fitted at the cut part of the base sheet by the repulsive force due to the porous member itself being compressed.

Examples of a nonwoven fabric suitably used as a porous member of the present invention are described below.

As a nonwoven fabric suitable used as a porous member of the present invention, a nonwoven fabric having the density of 0.01 to 0.20 g/cm³is preferable.

When the nonwoven fabric having the density of less than 0.01 g/cm³ is used, the capillary force is low and, as a result, problems in that the diffusion of ink is inhibited may be caused. When the nonwoven fabric having the density of more than 0.20 g/cm³ is used, the capillary force is low and, as a result, problems in that the diffusion of ink is inhibited may be caused.

A nonwoven fabric used as a porous member of the present invention preferably consists of a synthetic fiber having a fineness of from 0.1 to 72 dt.

When the fineness is less than 0.1 dt, the cavity between the fibers reduces, the porous nonwoven fabric is produced with difficulty, as a result, the ink blocks the porous parts and problems in that the diffusion of ink is inhibited may be caused.

When a nonwoven fabric having a fineness of more than 72 dt is used, the capillary force is low and, as a result, problems in that the diffusion of ink is insufficient may be caused.

In the present invention, a nonwoven fabric which has the density of from 0.01 to 0.20 g/cm³ and consists of synthetic fiber having the fineness of from 0.1 to 72 dt is most preferable.

As a nonwoven fabric used as a porous member of the present invention, the same as described for a base sheet is arbitrarily used. Among them, in particular, it is desirable to use a nonwoven fabric such as spun bond nonwoven fabric, thermal bond nonwoven fabric, chemical bond nonwoven fabric, needle punch nonwoven fabric, and stitch bond nonwoven fabric.

Examples of synthetic resin foam suitably used as a porous member of the present invention are described below.

In the present invention, as a porous member, synthetic resin foam in which the diameter of the pore size is within the range of from 0.01 to 3.0 mm is desirable.

The pore size of the present invention is defined as an average of the value obtained by taking a photograph expanded from 30 to 100 times with an electron microscope (SEM), choosing ten pores of the surface in the obtained photographs, and measuring the longest length as the major axis in each pore.

When the major axis of the pore size is less than 0.01 mm, the pigment component or the like in the ink blocks the porous parts because the pore diameter is small and, as a result, problems in that the diffusion of ink is inhibited may be caused. When the major axis of the pore size is more than 3.0 mm, problems in that diffusion is not caused and the ink is built up only at the bottom of a porous member fitted with the ink may be caused because the capillary force is insufficient.

As synthetic resin foam used in the present invention, foam of various types of polyolefin resin including polyurethane foam, polyvinyl chloride foam, PVA foam, SBR foam, or the like can be suitably used, in particular.

### EXAMPLES

The present invention will now be described in more detail by way of examples, but the present invention is not limited to the following examples. In the following examples, parts and percentages are by weight unless otherwise specified.

The detailed present invention is explained according to the following examples.

### Example 1

A center part of a base sheet 1 was punched to the size of 20 mm×20 mm. Then, a porous member 1 was punched to the size of 20 mm×8.5 mm, compressed in the direction of thickness to be 20 mm thick, and fitted into the punched part of the base sheet 1 to obtain an ink absorbent (shown in FIG. 3).

### Example 2

A center part of a base sheet 1 was punched to the size of 40 mm×20 mm. Then, a porous member 1 was punched to the size of 40 mm×8.5 mm, compressed in the direction of thickness to be 20 mm thick, and fitted into the punched part of the base sheet 1 to obtain an ink absorbent (Figure was omitted).

### Example 3

A center part of a base sheet 2 was punched to the size of 40 mm×20 mm. Then, a porous member 1 was punched to the size of 40 mm×8.5 mm, compressed in the direction of thickness to be 20 mm thick, and fitted into the punched part of the base sheet 2 to obtain an ink absorbent.

### Example 4

A center part of a base sheet 1 was punched to the size of 20 mm×20 mm. Then, a porous member 2 was punched to the size of 20 mm×8.5 mm and fitted into the punched part of the base sheet 1 to obtain an ink absorbent.

### Example 5

A center part of a base sheet 2 was punched to the size of 20 mm×20 mm. Then, a porous member 2 was punched to the size of 20 mm×8.5 mm and fitted into the punched part of the base sheet 2 to obtain an ink absorbent.

### Example 6

A center part of a base sheet 1 was punched to the size of 20 mm×20 mm. Then, a porous member 3 was punched to the size of 20 mm×8.5 mm, compressed in the direction of thickness to be 20 mm thick, and fitted into the punched part of the base sheet 1 to obtain an ink absorbent.

### Example 7

A center part of a base sheet 3 was punched to the size of 40 mm×20 mm. Then, a porous member 1 was punched to the size of 40 mm×8.5 mm, compressed in the direction of thickness to be 20 mm thick, and fitted into the punched part of the base sheet 3 to obtain an ink absorbent.

### Example 8

A center part of a base sheet 3 was punched to the size of 20 mm×20 mm. Then, a porous member 2 was punched to the size of 20 mm×8.5 mm, compressed in the direction of thickness to be 20 mm thick, and fitted into the punched part of the base sheet 3 to obtain an ink absorbent.

### Comparative Example 1

A base sheet 1 as was, which was not fitted with a porous member, was an ink absorbent.

### Comparative Example 2

A base sheet 2 as was, which was not fitted with a porous member, was an ink absorbent.

### Comparative Example 3

A base sheet 3 as was, which was not fitted with a porous member, was an ink absorbent.

### Reference Example

A base sheet 4 as was, which was not fitted with a porous member, was an ink absorbent.

Base sheets and porous members used in examples and comparative examples are explained below.

### (Base Sheet 1)

PET spun bond nonwoven fabric (product name: Ecule® produced by Toyobo Co., Ltd.) having the basis weight of 15 g/m² was let out on a driving endless conveyor in the form of mesh, 8 g/m² of PE powder to be an adhesive agent was sprayed on it, after blending cellulose fiber obtained by fibrillating commercially available LBKP in a dry fibrillating machine and thermal adhesive fiber (PE/PP bicomponent fiber, the fiber length of 5 mm, the fineness of 1.7 dt, product name: ESC871 produced by ES FiberVision) in the mass ratio of 2.35:1 and uniformly mixing them in air, the mixture was dropped with airflow by an air-lay web forming apparatus and accumulated on the sprayed adhesive agent, 8 g/m² of the same above PE powder was sprayed on the accumulated mixture, the same above PET spun bond nonwoven fabric was laminated to form a web, the web was passed through a through-air dryer set to the temperature of 138° C. and pressed, and a dry nonwoven fabric having the basis weight of 850 g/m², the thickness of 8.5 mm, and the density of 0.100 g/cm³ was obtained.

In addition, the dry nonwoven fabric which was punched to a square shape of 100 mm×100 mm was defined as base sheet 1.

### (Base Sheet 2)

PET spun bond nonwoven fabric (product name: Ecule® produced by Toyobo Co., Ltd.) having the basis weight of 15 g/m² was let out on a driving endless conveyor in the form of mesh, 8 g/m² of PE powder to be an adhesive agent was sprayed on it, after blending cellulose fiber obtained by fibrillating commercially available LBKP in a dry fibrillating machine and thermal adhesive fiber (PE/PP bicomponent fiber, the fiber length of 5 mm, the fineness of 1.7 dt, product name: ESC871 produced by ES FiberVision) in the mass ratio of 2.35:1, adding 85 g/m of borax into them, and uniformly mixing them in air, the mixture was dropped with airflow by an air-lay web forming apparatus and accumulated on the sprayed adhesive agent, 8 g/m² of the same above PE powder was sprayed on the accumulated mixture, the same above PET spun bond nonwoven fabric was laminated to form a web, the web was passed through a through-air dryer setting to the temperature of 138° C. and pressed, and a dry nonwoven fabric having the basis weight of 850 g/m², the thickness of 8.5 mm, and the density of 0.100 g/cm³ was obtained.

In addition, the dry nonwoven fabric which was punched to a square shape of 100 mm×100 mm was defined as base sheet 2.

### (Base Sheet 3)

Base sheet 3 was obtained by the same method as the method of producing base sheet 2, except that 85 g/m² of Nonnen R-0128® (produced by Marubishi oil chemical Co., Ltd., nitrogen-phosphorus system flame retardant) instead of the borax was added.

### (Base Sheet 4)

A felt nonwoven fabric (product name: 5000AZ®, produced by Fuji Corporation), which was produced by using PET fiber (the fiber length of 29 mm and the fineness of 2.2 dt) in the needle punch method and has the basis weight of 1300 g/m², the thickness of 8.0 mm, and the density of 0.163 g/cm³, was punched to a square shape of 100 mm×10 mm to be defined as base sheet 4.

### (Porous Member 1)

A nonwoven fabric (product name: MICLOTH IC-800®, produced by Oji Kinocloth Co., Ltd.), which was produced by using PET fiber (the fiber length of 5 mm and the fineness of 2.2 dt) in the thermal bond method and has the basis weight of 800 g/m², the thickness of 25 mm, and the density of 0.032 g/cm³, was defined as porous member 1.

### (Porous Member 2)

A nonwoven fabric (product name: MICLOTH IC-550®, produced by Oji Kinocloth Co., Ltd.), which was produced by using PET fiber (the fiber length of 5 mm and the fineness of 2.2 dt) in the thermal bond method and has the basis weight of 550 g/m², the thickness of 20 mm, and the density of 0.028 g/cm³, was defined as porous member 2.

### (Porous Member 3)

A commercially available polyurethane resin foaming product (the average pore diameter of 0.3 mm, the basis weight of 420 g/m², and the density of 0.014 g/cm³) was cut to be 30 mm thick and the cut polyurethane resin foaming product was previously immersed in glycerin by a hydrophilic treatment to be defined as porous member 3.

The ink absorbents obtained by the examples and comparative examples were evaluated by the following method. The results are shown in Table 1.

### (Evaluation Method)

0.05 ml of test ink obtained by a method stated separately was dropped to the center area of a part fitted with a porous member in the ink absorbent obtained by examples and comparative examples (when a porous member was not fitted, the test ink was dropped to the center area of the whole ink absorbent), after that, the ink solvent component was completely dried by a drying apparatus.

In addition, 0.05 ml of the test ink was dropped to the part of the ink absorbent where the test ink has been dropped and dried and, after that, the ink solvent component was completely dried in the same manner as previously.

The above dropping and drying operation was repeated 350 times and the ink absorption rate and the surface state of the ink absorbent were observed every 50 to 100 times.

The ink absorption rate was evaluated by visual observation and an ink absorbent in which ink was absorbed in 3 seconds after dropping the ink was evaluated with A, an ink absorbent in which ink was absorbed in 4 to 9 seconds after dropping the ink was evaluated with B, an ink absorbent in which ink was absorbed in 10 seconds or more after dropping the ink was evaluated with C.

The ink accumulation was evaluated by visual observation and an ink absorbent in which an accumulation of an ink pigment component or composited component was not observed at the ink-dropped area at all was evaluated with A, an ink absorbent in which a little accumulation of an ink pigment component or composited component was observed was evaluated with B, an ink absorbent in which a gelled accumulation material of an ink pigment component or composited component was observed was evaluated with C, and an ink absorbent in which the height of a gelled accumulation material of an ink pigment component or composited component was 1 mm or more was evaluated with D.

### (Test Ink)

Among the following ink compositions (the ratio was based on the solid content), first, an acid carbon black and 50% by mass of ion-exchange water were dispersed by using a supersonic wave dispersing apparatus for 15 minutes and further dispersed by using a ball mill for ten hours.

The other compositions were added to the carbon black dispersion obtained as described above, and stirred by homomixer for 2 hours, and uniformly mixed to obtain a test ink.

### (Ink Composition)

| | |
|---|---|
| Acid carbon black (MA100 ® produced by Mitsubishi | 6% by mass |
| Chemical Corporation) | |
| Carboxymetyl-cellulose | 3% by mass |
| (Cellogen 7A ®, produced by Dai-ichi | |
| Kogyo Seiyaku Co., Ltd.) | |
| Potassium acetate | 0.5% by mass |
| Potassium sorbate | 0.5% by mass |
| Diethylene glycol | 45% by mass |
| Ion-exchange water | 45% by mass |

TABLE 1

| | Dropping 50 times | | Dropping 150 times | | Dropping 250 times | | Dropping 350 times | |
|---|---|---|---|---|---|---|---|---|
| | Ink | absorption | Ink | absorption | Ink | absorption | Ink | absorption |
| | accumulation | rate | accumulation | rate | accumulation | rate | accumulation | rate |
| Example 1 | A | A | A | A | A | A | B | A |
| Example 2 | A | A | A | A | A | A | A | A |
| Example 3 | A | A | A | A | B | B | B | B |
| Example 4 | A | A | A | A | A | A | A | A |
| Example 5 | A | A | A | A | B | A | B | B |
| Example 6 | A | A | A | A | B | B | B | C |
| Example 7 | A | A | A | A | A | A | B | A |
| Example 8 | A | A | A | A | A | A | B | A |
| Comparative | A | A | B | A | B | B | C | B |
| Example 1 | | | | | | | | |
| Comparative | B | B | C | B | C | C | D | C |
| Example 2 | | | | | | | | |
| Comparative | A | A | B | A | B | B | C | B |
| Example 3 | | | | | | | | |
| Reference | A | A | A | A | B | A | C | B |
| Example | | | | | | | | |

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as limited by the foregoing description but is only limited by the scope of the appended claims.

1. An ink absorbent comprising:
a base sheet comprising a dry nonwoven fabric having a density of 0.05 to 0.5 g/cm³; and
a porous member fitted to the base sheet, wherein
the density of the porous member is lower than that of the base sheet.

2. An ink absorbent according to claim 1, wherein the base sheet is formed by a cellulose fiber as a main body.

3. An ink absorbent according to claim 1, wherein the base sheet is formed by a synthetic fiber as a main body.

4. An ink absorbent according to claim 1, wherein the porous member is a nonwoven fabric having a density of 0.01 to 0.20 g/cm³.

5. An ink absorbent according to claim 4, wherein the nonwoven fabric is formed by a synthetic fiber having a fineness of 0.1 to 72 dt.

6. An ink absorbent according to claim 1, wherein the porous member is formed by a synthetic resin foam, the diameter of a pore size of which is within the range of from 0.01 to 3.0 mm.

7. An ink absorbent according to claim 2, wherein the porous member is a nonwoven fabric having a density of 0.01 to 0.20 g/cm³.

8. An ink absorbent according to claim 2, wherein the porous member is formed by a synthetic resin foam, the diameter of a pore size of which is within the range of from 0.01 to 3.0 mm.

9. An ink absorbent according claim 3, wherein the porous member is a nonwoven fabric having a density of 0.01 to 0.20 g/cm³.

10. An ink absorbent according to claim 3, wherein the porous member is formed by a synthetic resin foam, the diameter of a pore size of which is within the range of from 0.01 to 3.0 mm.

11. An ink absorbent according to claim 7, wherein the nonwoven fabric is formed by a synthetic fiber having a fineness of 0.1 to 72 dt.

12. An ink absorbent according to claim 9, wherein the nonwoven fabric is formed by a synthetic fiber having a fineness of 0.1 to 72 dt.
